(19) United States
(12) Patent Application Publication
(10) Pub. No.: US 2003/0187982 A1
(43) Pub. Date: Oct. 2, 2003

(54) System and method for resource load balancing in a portal server

(76) Inventor: Patrick Petit, Grenoble (FR)

Correspondence Address: WAGNER, MURABITO & HAO LLP, Third Floor, Two North Market Street, San Jose, CA, 95113, US

(21) Appl. No.: 10/108,122

(22) Filed: Mar. 27, 2002

(51) Int. Cl. G06F 15/173

(52) U.S. Cl. 709/225

(57) ABSTRACT

In an enterprise portal server system having a server, a resource load balancing method and system. The resource load balancing system includes logic for determining threshold load values for optimal performance of the portal server. Current load values in the portal server are intermittently calculated during a load sampling period to determine whether resource overload conditions exist in the portal server during the load sampling period. In one embodiment of the present invention, when resource overload is detected, a load balancing module automatically identifies under utilized resources in the portal server in order to distribute user processes or requests causing the overload conditions from the over utilized resources to the under utilized resources. In one embodiment load balancing conditions are automatically communicated to a system administrator for replicate configuration conditions in the portal server to remote resource connected to the portal server.

### CROSS REFERENCE TO RELATED APPLICATION

This application is related to co-pending U.S. patent application Ser. No.: ______ filed on ______ titled “SYSTEM AND METHOD OF DETECTING RESOURCE USAGE OVERLOADS IN A PORTAL SERVER”, attorney docket No.: Sun/P7145/ACM/DKA by Petit et al., and co-pending U.S. paten application Ser. No.: ______ filed on ______ . titled “SYSTEM AND METHOD OF DETERMINING THE NUMBER OF MEMORY FOR SIZING A PORTAL SERVER”, attorney docket No.: SUN/P7220/ACM/DKA and co-pending patent application Ser. No.: ______ filed on titled “SYSTEM AND METHOD OF DETERMINING THE NUMBER OF CENTRAL PROCESSING UNITS FOR SIZING APORTAL SERVER”, attorney docket No.: SUN/P7147/ACM/DKA. To the extent not repeated herein, the contents of the three above referenced patent application are hereby incorporated herein by reference.

### FIELD OF THE INVENTION

The present claimed invention relates generally to the field of corporate enterprise portal server systems. More particularly, embodiments of the present claimed invention relate to load balancing in portal servers.

### BACKGROUND ART

The Internet has become a dominant vehicle for data communications with a vast collection of computing resources interconnected as a network from sites around the world. And with the growth of Internet usage has come a corresponding growth in the usage of Internet devices, wireless devices and new services.

The growing base of Internet users has become accustomed to readily accessing Internet-based services, which traditionally were restricted or limited to the “client/server” environment, at any time from any location. Accessibility of traditional business services and products over the Internet means enterprises need to adjust to new paradigms of business transaction.

Business organizations are making a transition from unsophisticated network infrastructure to a sophisticated network infrastructure. Additionally, portal services are becoming an essential part of today's network-centric computing infrastructure. In making such a transition, efficient management of services and resources offered by such intelligent networks become critical. Today, many organizations have mission critical applications for users and policies on individually configurable desktop machines. This time-consuming individual configuration process is unsuitable for enterprises and service providers seeking to create intelligent networks.

User management and policy based tools for managing services are becoming an important requisite for intelligent networks which should be capable of dynamically providing services. Furthermore, as businesses extend their intranet services to extranets to include suppliers, business partners, and customers, providing access-control increases in size and complexity. Organizations responding to the rapidly changing conditions of today's business environments, need to simplify and automate the configuration and control of their services.

A virtual private network is a way to simulate a private network over a public network such as the Internet. The growth in the Internet and its popular information services, commonly known as the World Wide Web has led to a popularity in the use of corporate intranets. Internally, companies are running TCP/IP networks (intranets) pushing information to their internal web-sites using web browsers as a common collaborative tool.

The need to share data within and outside the company's internal network has also led to the popularity in community web-based applications or portals. These portals enable users to share community based data, applications, service, etc., within a company. The increasing using of such community based data sharing has led to the increasing use of portal servers that connect the variety of user base to the corporate intranet and the Internet.

Portal servers also provide a secure way of connecting the corporate intranet to the Internet thereby reducing the fears that sensitive information might leave the corporate network. A portal server also provides users the ability to connect to a corporate intranet via the Internet using a web browser without the user having to reconfigure their computer. The ease in connecting to corporate intranets via the portal server has made portal servers very attractive to many corporate information systems decision makers.

FIG. 1 is a block diagram illustration of a portal server environment. The portal server environment depicted in FIG. 1 comprises an enterprise portal server 110, a public network (the Internet) 115, a corporate intranet 120, back-end resource servers 130-140 and client computers 145-150. In the environment depicted in FIG. 1, client users 145-150 can directly access directories residing in the portal server 110 via the Internet 115 if such users are at a remote location. Similarly client 155 can access the same directory on the portal server 110 via the internal corporate intranet 120. Access to directories in the portal server 110 are subject to the user being authenticated by each individual application.

Since the portal server 110 may be accessed from a variety of venues (e.g., remotely or directly) the number of users accessing the portal server at any point in time can be very large. Thus, the load (e.g., transactions per second) on the server 110 can be very high. The number of users concurrently connecting or attempting to connect to the portal server 110, may impact the performance of the portal server 110. The response time of a portal server can also be based on the number of transactions it processes per second.

On average, directories running on a reasonably fast server can be expected to handle around 800 or more search requests per second and thousands of simultaneous directory connections. However, there are many factors that can impact the server's performance. These factors include the amount of memory available to the server, the number of entries in directory databases, the number of types of indexes that the server uses to respond to search requests, the amount of write activities performed on the server, etc.

As the load on the server grows, system administrators want to detect and balance the load in order to ensure optimal performance of the portal server 110. System administrators typically use various manual techniques to increase the performance of the server.

However, these manual determinations in performance improvements are done without any precise logic or formula to it. Thus, most of the server overload balancing of the portal server 110 are done on a manual trial-and-error basis. This can be an inefficient and ineffective way to improve the performance of the portal server 110.

### SUMMARY OF INVENTION

Accordingly, in order to prevent the undue performance burdens that current portal users frequently encounter as the number of users and applications that access network applications from portal servers via the Internet or intranet increase, there should be a way to for system administrators to automatically determine certain performance metrics to enhance resource load balancing of the portal server. There should also be a way to allow the user to access multiple applications in the portal server without experiencing performance delays due to a lack of appropriate performance metrics being implemented by the portal server as a result of the ineffective and inefficient load balancing methods.

As the number of business applications on the Internet increases, enterprise system users are looking for an easy and reliable way to access multiple applications in a web based application environment without the inefficiencies of the prior art. An Internet infrastructure system is needed that has extensibility capabilities to allow access authentication and authorization to web-based resources and services in a business enterprise environment. Further, a need exists for a system and method of tracking user access to network resources and application services in order to provide optimal server service within a business environment. A need further exists for “out-of-the-box” load balancing solutions to allow network system administrators to connect portal servers to existing corporate networks that have the capacity to support a large number of users without the attendant performance problems of the prior art. A need further exists for an improved and less costly device independent portal server system, which improves efficiency and provides access to web-based content to various users of different configurations without losing the embedded features designed for these devices.

What is described, in one embodiment, is an automatic resource load balancing system and method having a portal server supporting a load sizing tool for balancing resource load in the portal server. This system provides access to predetermined primary metrics and secondary resources and services in a corporate portal server system environment to generate the appropriate metrics to size the portal server. In one embodiment of the present invention, the portal server system includes an authentication service system that authenticates user access requests to the portal server. A user access request is typically directed to web-based software applications and services which may be specific to an organization or an entity. In one embodiment of the present invention, the authentication service system may additionally include a user agent policy system that sets user access policy to applications in the portal server.

Embodiments of the present invention include a resource sizing unit for determining an optimal number of central processing units (CPUs) for enhancing the performance of the portal server in light of the number of concurrent users connected to the portal server. Embodiments of the present invention use primary sizing factors such as the maximum number of users that can connect to the portal server and the maximum number of concurrent users that may connect to the portal server at a particular point in time.

Embodiments of the resource sizing unit of the present invention may also include a memory sizing module. The memory sizing module includes logic that allows a system administrator to automatically determine the optimal memory size to support the load on the server as the traffic on the server increases.

The present invention may further include a session service that monitors a user's session after the user has been authenticated to access particular files or directories in the portal server. The session service bypasses user re-authentication after the user has been initially authenticated and validated. The session service also monitors the user access requests to directories in the portal server.

Embodiments of the present invention may also include a load detection module for detecting a load increase on the server. The load increase in the server may be due to the increase in the number of concurrent users accessing various resources and applications, particularly directory resources, on the server.

Embodiments of the present invention may further include a load balancing module for balancing resources usage in the portal server to prevent overload conditions and to automatically and dynamically determine the point where the performance of the portal server starts to decrease for a given server configuration. The load balancing module automatically identifies overload conditions in the portal server and initiates remedial processes to reduce the load in the portal server.

Embodiments of the load balancing module of the present invention include a set of dynamic register counters that are used by the load detection module to identify the performance throughput of the portal server based on the highest throughput from system start-up time and the lowest transaction time for a given time period. By monitoring the performance trend of the two curves, the “sweet spot” in server performance can be determined. This information can be transmitted to the load balancing module on which to make decisions. A counter for the maximum number of transactions per second and the minimum transactions time can be provided. These counters can be read to measure the sweet spot.

These set of register counters store processing time values of the portal server during user requests to resources and applications in the portal server. The processing times of user requests are captured during various load data capture periods during the day to enable the system administrator to automatically detect load conditions of the portal server at those various periods.

Embodiments of the present invention further include a request control module for monitoring user directory lookup requests to the portal server of the present invention. Each time a user performs a directory lookup, that lookup represents a single request to the portal server. As the number of directory lookups increase, the load on the portal server increases. The request control module monitors these lookup request in order to calculate and balance the number of requests at any time on the portal server.

Embodiments of the present invention further include an access control module for monitoring the number of disk accesses that the portal server performs at any given time. The number of disk accesses determines the speed at which the server performs. The more disk accesses that are made in the portal server, the slower the performance of the server. The access control module monitors disk accesses and determines when to spread disk requests in a portal server having a network of disks to handle user requests, thereby balancing the load over several disks.

Embodiments of the present invention further include a load replication module for enabling a system administrator to automatically balance resource usage load on the portal server by replicating resource configurations in the portal server on remote servers connecting to the portal server to handle user requests without interfering with user operations.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

FIG. 1 is a block diagram of a portal server environment of the prior art;

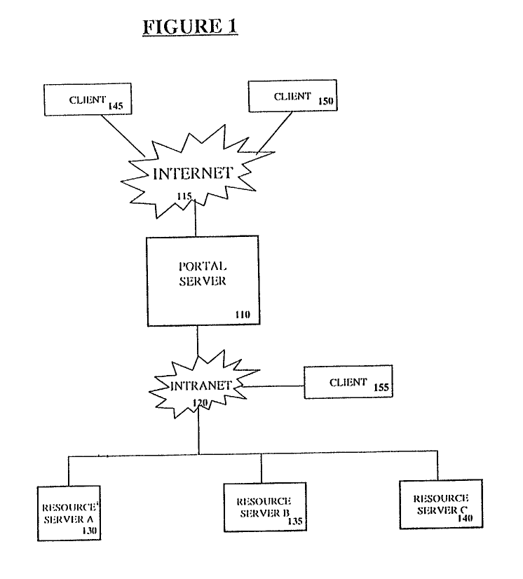

FIG. 2 is a block diagram of one embodiment of the portal server environment of the present invention;

FIG. 3 is a block diagram of one embodiment of the portal server of the present invention;

FIG. 4 is a block diagram of one embodiment of the performance requirements assessment module of the present invention;

FIG. 5 is a block diagram of an embodiment of the architecture of the load balancing system of the present invention;

FIG. 6 is a flow diagram of one embodiment of load balancing resource usage in a portal server of the present invention; and

FIG. 7 is a graph of a load as a function of the response time of a transaction of one embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

Embodiments of the invention are directed to a system, an architecture, subsystem and method to determine the optimal load required by a portal server for optimum performance of maximum throughput with minimum transaction time in a way superior to the prior art.

In the following detailed description of the present invention, a system and method for load balancing in a portal server are described. Numerous specific details are not set forth in order to provide a thorough understanding of the present invention. However, it will be recognized by one skilled in the art that the present invention may be practiced without these specific details or with equivalents thereof.

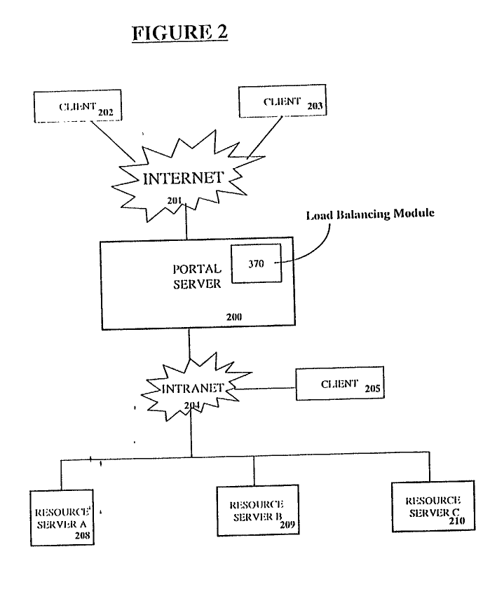

FIG. 2 is a block diagram illustration of a portal server environment. The portal server environment depicted in FIG. 2 comprises a portal server 200, a plurality of desktop or wireless clients 202 and 203 which are connected to the Internet 201, intranet 204, client 205 and back-end resource servers 208-210. In the environment depicted in FIG. 2, a user 202 or 203 can directly access the portal server 200 either via the Internet 201 or the intranet 204. As further depicted in-FIG. 2, the portal server 200 comprises a load balancing module 370 of the present invention.

In the environment depicted in FIG. 2, for the user to access protected resources or services, the user must authenticate. If the user authenticates successfully and if the user is authorized to access the resources, the user is given access to the resource. Content provided by the portal server 200 are provided in the form of various directories that may include content aggregated from the back-end resource servers 208-210. In the environment shown in FIG. 2, the portal server 200 tracks the initial desktop displays after the client has authenticated to the portal server 200 and the desktop reloads in order to generate the correct metrics to measure the throughput of the portal server 200.

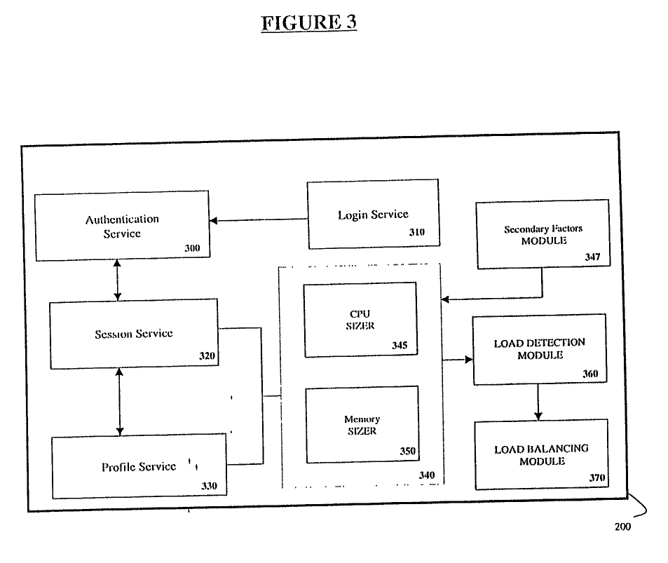

FIG. 3 is a block diagram depiction of one embodiment of the portal server 200 of the present invention. In the exemplary diagram shown in FIG. 3, the portal server 200 comprises authentication module 300, login module 310, session module 320, profile module 330, sizing module 340 comprising CPU sizing module 345 and memory sizing unit 350, secondary factors module 347, load detection module 360 and load balancing module 370.

The authentication module 300 provides sign on service authentication of the present invention. The authentication module 300 provides the portal server 200 (FIG. 2) with the logic and option to protect Internet software applications and services from unauthorized authenticated users of these applications.

The authentication module 300 of FIG. 3 further provides the portal server 200 with the access implementation logic to selectively allow access to specified applications and services within enterprise organizations. By selectively allowing only authorized and authenticated users access to particular files within an organizations file database, the authentication module 300 ensures that corporate enterprise resources are efficiently and effectively utilized by authorized users only.

Further, the authentication module 300 allows authenticated users of the portal server 200 continuous and uninterrupted use of resources and applications available on the server 200. This enables the sizing logic 340 of the present invention to accurately determine the number of users that are connected to the portal server 200 at any time.

The login module 310 provides login services to the portal server 200. Login module 310 includes logic to enable the tracking of a user's password to enable the sign-on services of the authentication process to function in the server 200.

Still referring to FIG. 3, the session module 320 provides a session tracking mechanism to enable the authentication logic of the present invention to track a user's login session to the portal server 200. The session module 320 logs the user's access of each application for which the user is authenticated to access. By logging the user's access to applications on the portal server 200, the authentication module is able to automatically authenticate the user's access to subsequent applications, after the initial login, without requiring a separate manual re-login.

The profile-module 330 provides user profile information to the authentication module 300. The profile module 330 provides an XML over http(s) interface for obtaining user, service and policy information. A user's profile information typically includes the user-name, the user's password and, the user's entity within a particular organization.

The profile information further defines the user's application access rights which determine or set forth user's rights to files and directory within applications and resources in portal server 200.

Central processing unit resource depletion in the portal server 200 is driven by the number of concurrent requests the portal server 200 has to process per unit of time. Depletion of CPU resources generally results in degraded response time as a result of request queuing. The CPU sizing module 345 includes logic to monitor the number of users connected to the portal server 200, the maximum number of concurrent users connected to the portal server 200 and other secondary factors associated with the clients desktops connected to the portal server 200 to determine performance metrics to enhance the performance of the portal server 200. The CPU sizing module 345 provides a mechanism by which a system administrator can determine the number of CPUs a particular portal server may need to provide an efficient and effective utilization of the underlying portal resources by the users connected to the portal server 200.

The function of CPU sizing Module 345 is described in co-pending U.S. patent application entitled “SYSTEM AND METHOD OF DETERMINING THE NUMBER OF CENTRAL PROCESSING UNITS FOR SIZING A PORTAL SERVER”, filed ______ , Ser. No.: ______ assigned to the assignee of the present invention and hereby incorporated herein by reference.

Memory resource depletion in the portal server 220 is driven by the number of outstanding sessions. Memory depletion typically results in degraded response time as a result of the increase garbage collection overhead and out-of memory exceptions in the portal server 200.

The memory sizing module 350 includes logic to monitor the number of users connected to the portal server 200, the maximum number of concurrent users connected to the portal server 200 and other secondary factors associated with the portal server 200 to determine performance metrics to enable the load detection module determine overload conditions of the portal server 200. The memory sizing module 350 provides a mechanism by which a system administrator can automatically determine the memory size that a particular portal server may need to provide an efficient and effective utilization of the underlying portal resources by the users connected to the portal server.

The function of memory sizing module 350 is described in the co-pending U.S. patent application entitled “SYSTEM AND METHOD OF DETERMINING MEMORY USAGE FOR SIZING A PORTAL SERVER”, Ser. No.: ______ filed ______ , assigned to the assignee of the present invention and hereby incorporated herein by reference.

The secondary factor module calculates secondary factors such as the number of concurrent users connected to the portal server 200, the maximum number of users connected to the portal server 200, etc. Data from the secondary factors module is provided to the sizing module 340 and the load detection module 360 respectively. In one embodiment of the present invention, the count of the maximum number of connected users and the number of concurrent requests are provided by the secondary factors module 347 to the load detection module 360 to help determine the threshold load conditions in the portal server 200.

The load detection module 360 monitors resource usage by users concurrently connected to the portal server 200 in order to detect overload conditions in the portal server. In one embodiment of the present invention, the load detection module 360 is programmable to capture load conditions in the portal server 200 during sampling periods. The load sampling periods of the load detection module 360 may last from a few seconds to a few minutes.

During the load sampling period, the load detection module 360 examines the current load values in the portal server 200 and compares those values with the pre-determined threshold optimal load values stored in the load detection module 360 to determine whether the current load values exceed the threshold values or the load values from the most previous sampling period. In one embodiment of the present invention, the load sampling period is programmable to be random or serialized over specific times of the day during system up-time.

The function of the load detection module 360 is described in the co-pending U.S. patent application entitled “SYSTEM AND METHOD OF DETECTING RESOURCE USAGE OVERLOADS IN A PORTAL SERVER”, Ser. No.: ______ filed ______ , assigned to the assignee of the present invention and hereby incorporated herein by reference.

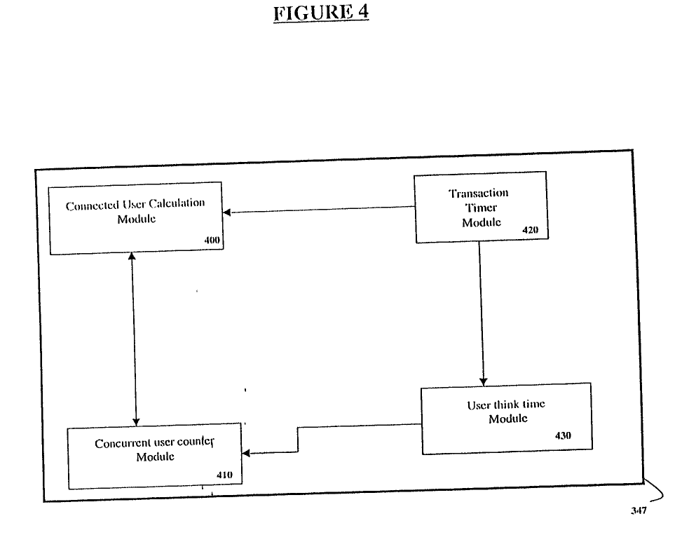

FIG. 4 is block diagram depiction of one embodiment of the performance requirement assessment module 347 of the present invention. The performance requirement assessment module 347 comprises a connected user calculation module 400, a concurrent user counter 410, transaction timer module 420 and user think time module 430.

The connected user calculation module 400 calculates the maximum number of users or sessions connected to the portal server 200. A connected user is a user who has a valid portal session open, but who may not be active at a certain time. The maximum number of users is generally a percentage of the user base that can be obtained from different sources, such as usage statistics or web traffic analysis for an already existing portal or web application.

The web traffic metric representing the best value to calculate the maximum number of connected users is often called visitor sessions (e.g., a single visitor visit within a predefined period of time). Depending on the portal audience and portal type (e.g., business to employee or business to customer portal), that percentage can vary from a fraction of the user base to the entire user base. For example, in a corporate environment, the total user base may be based on the number of active employees, not including employees that are either on the road, on vacation, or are out sick.

In the present invention, another variable used to calculate the maximum number of connected users by the connected user calculation module 400 is whether the maximum number of users calculated were calculated based on regular or peak server load conditions. The periodicity and amplitude of the peaks of load can substantially vary over time, but once they have been identified, the resulting number of connected users tends to be relatively steady for the observed period.

In one embodiment of the present invention, to calculate the maximum number of concurrent users, the concurrent user calculation module 410 uses a user interactivity profile to determine the number of users connected to the portal server 200. The user interactivity profile defines the number of hits registered to the portal server 200 per unit of time called the reference time period.

The concurrent user counter module 410 is coupled to the connected user calculation module 400 to tabulate the maximum number of concurrent users connected to the portal server 200 at any point in time. The contents of the concurrent user counter module 410 is provided to the load detection module 360 during a load sampling period to enable the load detection module 360 to determine whether the current count of concurrent users or requests exceed the pre-determined threshold values.

The user think time module 430 is coupled to calculate the user think time. The user think time defines the time elapsed between desktop clicks resulting in HTTP operations to the portal server 200 as opposed to the external resource servers 208-210 (FIG. 2). From the portal server's perspective, the think time could be anything from the time taken by the user to enter the user's authentication credentials, the time taken by the user to read a portal page or even the user's session or idle time-out if the user walks away from his desktop for an extended period of time. The think time then amounts to idle times for the portal server 200 and is equivalent to no user at all, except until the session is terminated (logout or session time-out).

Still referring to FIG. 4, the transaction timer module 420 is coupled to the connected user calculation module 400 and the think time module 430 to determine the transaction time for a user to complete an operation. The transaction time is the delay taken for an HTTP or HTTP(s) operation to complete. The metric gathered from this includes the aggregated send time, processing time and response time sub-metric. Depending on a browser's connection, speed, send time and response time delay may vary.

Typically, a response time delay will be longer with a connection speed of about 33.6 Kps than with a LAN connection speed. However, the processing time remains constant. The portal server 200 is timed so that the processing time under regular or peak load conditions does not exceed a certain threshold as far the performance requirements are concerned.

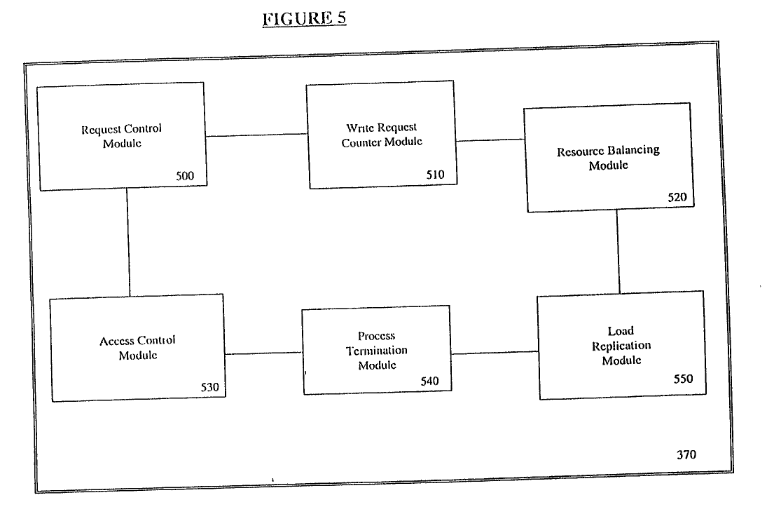

FIG. 5 is a block illustration of one embodiment of the load balancing module 370 of the present invention. As shown in FIG. 5, the load balancing module 370 comprises request control module 500, write requests counter 510, resource balancing module 520, access control module 530, process termination module 540 and load replication module 550.

As the load on the portal server 200 increases, the response time to user requests to the portal server 200 increases. Consequently, the computing power to service the increased traffic is increased. The load balancing module 370 of the present invention provides the portal server 200 with a means to automatically balance resource load in the portal server 200 in order to reduce the response time to handle user requests.

The load balancing module 370 balances resource overloads by identifying various sources that may contribute to increase request processing time and response time. These sources may include the number of concurrent users connected to the portal server 200, the length of time a user's request has been active in the portal server, the number of “dead” processes still pending in the portal server, the number of disk accesses to disks in the portal server 220, the number of requests makes to directories, etc.

The portal server's 200 ability to handle an increase in the load conditions depends on a few potential performance degrading factors. The factors may include the speed of the underlying CPU, the amount of memory available to the portal server, the number of access control statements included in directories in the server, the amount of write activities performed by users, etc.

To handle these potential performance degrading factors, system administrators sometimes have to simply add hardware to the existing server hardware such as memory to handle the increased load. However, sometimes the system administrator may have to automatically replicate the existing server to other remote servers or resources connected to the portal server 200 to handle the additional load.

The request control module 500 monitors user directory lookups in directories on disks in the portal server 200. As the load of user's directories grows, the computing power of the portal server 200 is increased to service the increased traffic. Each time a user performs a directory lookup, that lookup represents a single search request and as the requests increase, the performance of the server 200 may be impacted.

In one embodiment of the present invention, the system administrator assumes that every user will perform an average of ten (10) search requests per day. Therefore, if the portal server 200 has 10,000 users connecting to use directory services, then there is approximately 100,000 search requests per day, or about 1.15 search requests per second over a 24-hour period. Thus, the system administrator can balance the load on the portal server 200 by granting access to directory lookups only if access control is turned on for the server during certain times during the day.

The write request counter module 510 monitors write requests from users to the portal server 200. The number of write activities performed by the portal server 200 may slow or have no effect on the performance of the portal server 200. Directory writes are significantly slower than directory searches because they require disk accesses and may require index creation.

Thus, the more writes that the portal server 200 performs, the slower the overall search performance. In one embodiment of the present invention, the write request counter module 510 enables the portal server 200 to spread user search activities across several disks or servers that connect to the portal server 200. In another embodiment of the present invention, the write request counter module 510 controls writes request from users by restricting user activities to read-only activities thereby reducing the number of searches that the portal server 200 may have to perform.

The resource balancing module 520 monitors resource usage, such as memory, CPU use in the portal server 200 to automatically notify the system administrator when to add resources to the portal server 200. For example, the amount of RAM available for the portal server 200 should be enough for the entire database to reside in memory. The number of entries, types of indexes that are used in directory accesses impact the performance of the portal server 220. The resource balancing module 520 monitors the various hardware and software resources available to the portal server 220 and distributes load evenly over the resources, especially hardware resources, when it detects overload conditions on a particular resource.

In one embodiment of the present invention, the resource balancing module 520 monitors system resource usage in the portal server and identifies those resources that are under-utilized in order to allocate those resources to user request. In one embodiment of the present invention, the resource balancing module 520 automatically notifies the system administrator of excess resource capacity in order to enable the system administrator to perform manual resource allocation in the portal server 200.

The access control module 530 monitors user access requests to the portal server 200. As more users issue requests to various directories or conduct searches on the portal server 220, the performance of the portal server 200 degrades. The access control module 530 can be automatically turned on or off to restrict the number of users performing, for example, write requests to the portal server 200 at any time.

The process termination module 540 monitors user requests to the portal server 200 and terminates requests that are deemed to have existed too long on the server 200. The system administrator can set process expiration times in the portal server 200 and the process termination module 540 monitors user requests based on the time set by the system administrator to determine which requests to terminate in the event of system overload conditions.

The load replication module 550 provides the system administrator of the portal server 200 with an automatic “on the fly” means to replicate disk configurations, directory setups, etc., of resources in the portal server 200 to remote resources connecting to the portal server 200. In one embodiment of the present invention, the system administrator may implement the load replication module 550 during off peak hours when use of the portal server 200 is low.

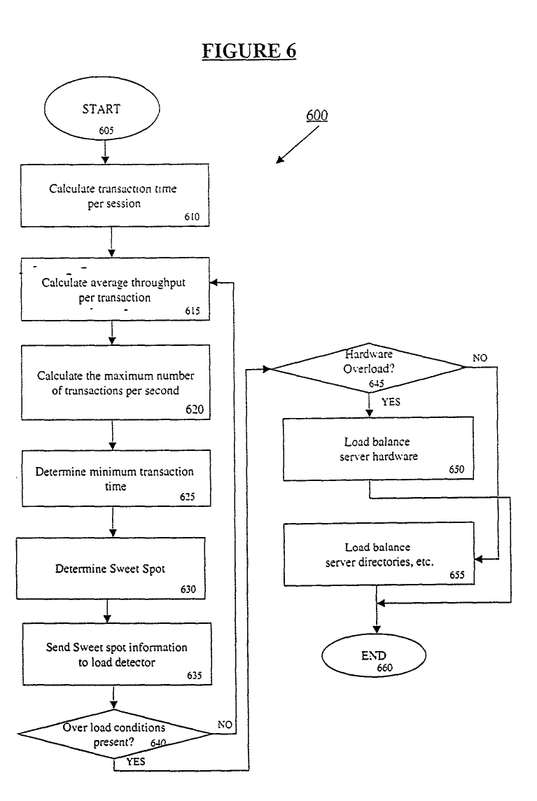

FIG. 6 is a flow diagram of one embodiment of the load balancing process of the present invention. As illustrated in FIG. 6, determining system overload conditions in the portal server 200 is initiated 605 by calculating the transaction time per each user session to the portal server 200 at step 610. At step 615, the average throughput per each user transaction is calculated.

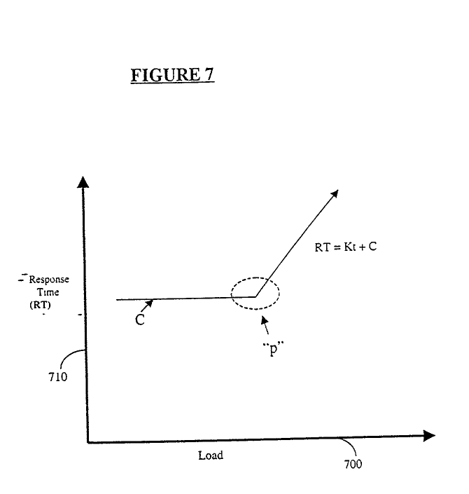

At step 620, the maximum number of transaction per second in the portal server 200 is calculated and at step 625, the load balancing module 370 determines the minimum transaction time for each user transaction being monitored in the portal server 200. For every give period of time that is configurable (e.g., 20 sec, 30 sec or 1 min), the load balancing module 370 calculates the transaction time and the average throughput of transaction in the portal server 200. A graph of the performance trend of the transaction time and the corresponding throughput is shown in FIG. 7. By monitoring the monitoring the performance trend of the two curves shown in FIG. 7, the load balancing module 370 determines the “sweet spot” at step 630 when performance conditions are optimal (e.g., no overload or under-load conditions) in the portal server 200.

At step 635, the sweet spot information is provided to the over load detection module 360. At step 640 the overload detection module 360 determines whether there is any resource (hardware or software) overload in the portal server 200. If an overload condition is detected in the portal server 200, the overload detection module 360 determines whether the overload condition is a hardware resource overload at step 645.

If the overload condition is determined to be hardware resource related, the load balancing module 370 initiates a hardware load balancing process at step 650 to determine which hardware resource (e.g., CPU, memory, etc.) to balance to mitigate the overload condition. If, on the other hand, the overload condition is determined to be software resource related, the load balancing module 370 initiates a software resource balancing sequence to determine which software resource ( e.g., directories, user write requests, etc.) is contributing to the overload conditions in the portal server 200.

FIG. 7 is a graph of a load as a function of the response time of transactions handled in the portal server 200. As shown in FIG. 7, the load balancing module 370 determines the point where the performance for each additional load on the server 200 begins to degrade performance of the server. The graph shows that performance for loads in the server 200 is constant for each new load, until point “p”, when additional load on the server 200 contributes to overall performance degradation. As shown in FIG. 7, when the load conditions in the server 200 pass the optimum performance sweet spot “p”, the response time increases linearly according to the following equation:

RT=Kt+C, where RT is the response time expressed in milliseconds and kt is the number of concurrent users (load) and C is a constant load factor.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A portal server, comprising:
an authentication module for authenticating user credentials for users connecting to said portal server;
a resource sizing module for determining an optimal number of central processing units and memory required by said portal server for optimum performance;
a load detection module for detecting resource usage overload conditions defining a maximum number of concurrent users or user requests processed in said portal server, and
a load balancing module for balancing resource usage overload conditions.

2. The portal server of claim 1, wherein said load balancing module comprises a user request control module for monitoring user requests directories residing in the portal server.

3. The portal server of claim 2, wherein said user request control module further tracks user lookups to directories in said portal server to detect excess access to said directories in order to balance said directories over hardware resources in said portal server.

4. The portal server of claim 3, wherein said load balancing module further comprises a user write request counter module for monitoring user write requests to said hardware resources in said portal server.

5. The portal server of claim 4, wherein said hardware resources further comprise random access memory.

6. The portal server of claim 5, wherein said hardware resources further comprise central processing units.

7. The portal server of claim 6, wherein said hardware resources comprise storage disks.

8. The portal server of claim 7, wherein said load balancing module further comprises a system resource balancing module for monitoring resource utilization in said portal server and identifying excess resource capacity in said portal server.

9. The portal server of claim 8, wherein said system resource balancing module further automatically allocates user requests from overloaded resources in said portal server to under utilized resources in said portal server.

10. The portal server of claim 9, wherein said system balancing module further automatically notifies a system administrator of said portal server of an availability of excess resource capacity in order to allow manual resource allocation.

11. The portal server of claim 10, wherein said load balancing module further comprises a resource access control module for monitoring user access requests to said portal server

12. The portal server of claim 11, wherein said resource access control module is automatically selectively enabled and disabled to restrict user access operations to particular resources in said portal server during said particular resources overload conditions.

13. The portal server of claim 12, wherein said load balancing module further comprise a process termination module for monitoring user initiated system processes in said portal server to determine expiration times of said user processes.

14. The portal server of claim 13, wherein said process termination module further terminates expired user processes in said portal server during said resource usage overload conditions in said portal server.

15. The portal server of claim 14, wherein said load balancing module further comprises a load replication module for automatically identifying hardware resources remotely coupled to said portal server to replicate system configurations settings in said hardware resources.

16. A resource load balancing system for balancing resource use overload conditions in a portal server, comprising:
a resource request control unit for controlling user requests to said portal server;
a user write request counter unit for monitoring user write requests to system resources coupled to said portal server; and
an overload balancing condition unit for monitoring said overload conditions in said portal server to automatically generate load balancing signals to a system administrator of said portal server.

17. The resource load balancing system of claim 16, wherein said system resources comprise random access memory.

18. The resource load balancing system of claim 17, wherein said system resources further comprise central processing units.

19. The resource load balancing system of claim 18, wherein said system resources further comprise storage disks.

20. The resource load balancing system of claim 16, wherein said overload balancing unit further automatically allocates user requests from overloaded resources in said portal server to under utilized resources in said portal server.

21. The resource load balancing system of claim 16, further comprising a resource access control unit for monitoring user access requests to the portal server.

22. The resource load balancing system of claim 21, wherein said resource request control module is automatically selectively enabled and disabled to restrict user access operations to particular resources in said portal server during said resource overload conditions.

23. The resource load balancing system of claim 16, further comprising a process termination module for monitoring user initiated system processes in said portal server to determine expiration times of said user processes.

24. The resource load balancing system of claim 23, wherein said process termination module further terminates expired user processes in said portal server during said resource use overload conditions in said portal server.

25. The resource load balancing system of claim 16, wherein said overload balancing condition unit further comprise a load replication module for automatically identifying hardware resources remotely coupled to said portal server to replicate system configurations settings in said hardware resources.

26. A method of load balancing a portal server, comprising:
authenticating user credentials for users connecting to said portal server;
determining an optimal number of central processing units and memory required by said portal server for optimum performance;
detecting resource usage overload conditions defining a maximum number of concurrent users or user requests processed in said portal server; and
balancing resource usage overload conditions.

27. The method of claim 26, wherein said balancing resource usage overload conditions comprises monitoring user requests directories residing in the portal server.

28. The method of claim 27, wherein said monitoring user requests directories further comprises tracking user lookups to directories in said portal server to detect excess access to said directories in order to balance said directories over hardware resources in said portal server.

29. The method of claim 28, wherein said balancing resource usage further comprises monitoring user write requests to said hardware resources in said portal server.

30. The method of claim 29, wherein said hardware resources further comprise random access memory.

31. The method of claim 30, wherein said hardware resources further comprise central processing units.
